(19) United States
(12) Patent Application Publication
(10) Pub. No.: US 2014/0064815 A1
(43) Pub. Date: Mar. 6, 2014

(54) IMAGE FORMING APPARATUS

(71) Applicant: CANON FINETECH INC., Misato-shi (JP)

(72) Inventor: Shusaku Takahata, Moriya-shi (JP)

(73) Assignee: CANON FINETECH INC., Misato-shi (JP)

(21) Appl. No.: 13/951,831

(22) Filed: Jul. 26, 2013

(30) Foreign Application Priority Data
Aug. 31, 2012 (JP) 2012-192239

(51) Int. Cl. G03G 15/00

(52) U.S. Cl. CPC G03G 15/65
USPC 399/397

(57) ABSTRACT

An image forming apparatus, including: an image forming portion configured to form an image on a recording material; and a conveyance roller pair configured to nip and convey the recording material, at least one of the conveyance roller pair having: a contact portion configured to come into contact with the recording material when the recording material passes through the conveyance roller pair; and a non-contact portion configured to be out of contact with the recording material when the recording material passes through the conveyance roller pair, wherein the non-contact portion is provided with a static electricity eliminating function to discharge an electric charge imparted on the recording material.

### BACKGROUND OF THE INVENTION

1. Field of the Invention

The present invention relates to an image forming apparatus configured to form an image on a recording material such as paper.

2. Description of the Related Art

As one of the problems with the image forming apparatus such as a copying machine, a laser beam printer, and a facsimile machine, there is a problem of static electricity to be generated due to charging by friction, separation, or the like when a sheet is conveyed. The static electricity causes a conveyance failure such as a paper jam and a paper skew, and further, the sheet is partially charged with the static electricity so that an uneven image is formed due to a difference in charging amount, resulting in a trouble such as a decrease in image quality.

Such static electricity has conventionally been prevented in the following manners. Specifically, a metal roller and a rubber roller are used in pairs as a recording material conveying member of the image forming apparatus, and the static electricity of the recording material is eliminated by utilizing conductivity of the metal roller. Further, a metal antistatic plate having a plurality of pointed protrusions is provided inside the rubber roller, and the plurality of pointed protrusions are located in the vicinity of a surface of the rubber roller and arranged in a longitudinal direction of the rubber roller (Japanese Patent Application Laid-Open No. H05-147316).

Further, a static elimination needle or a static elimination fabric is provided in a conveyance path, and is arranged so as to maintain a constant distance from the recording material, thereby eliminating electric charges imparted on the recording material (Japanese Patent Application Laid-Open No. 2008-7329).

In the conventional technology disclosed in Japanese Patent Application Laid-Open No. H05-147316, however, the static elimination effect is poor except for the part at which the pointed protrusions of the antistatic plate are provided, and hence the static electricity cannot be eliminated uniformly in a circumferential direction of the roller. Further, the electric charges imparted on the recording material by friction against a sheet feeding roller provided upstream of the rubber roller cannot be eliminated completely.

Further, in the case of using the static elimination fabric in the conveyance portion as disclosed in Japanese Patent Application Laid-Open No. 2008-7329, the distance between the static elimination fabric and the recording material fluctuates due to a change in behavior of the recording material and a curl of the recording material taking place at the time of printing on the second surface in the duplex printing. As a result, the static elimination may become insufficient. Further, the static elimination effect is decreased due to chipping of the static elimination fabric caused by contact with the recording material being conveyed, and to accumulation of paper dust. Therefore, periodic maintenance may be required.

### SUMMARY OF THE INVENTION

In view of the above, the present invention provides an image forming apparatus configured to perform static elimination of a recording material in a stable and uniform manner by reducing non-uniform static elimination, and further capable of preventing an image defect, such as an uneven image formed due to non-uniform charging, without influence of a curl of the recording material or the like.

According to an exemplary embodiment of the present invention, there is provided an image forming apparatus, including: an image forming portion configured to form an image on a recording material; and a conveyance portion configured to convey the recording material so that the image is formed on the recording material by the image forming portion, the conveyance portion including a conveyance roller pair configured to nip and convey the recording material, wherein at least one conveyance roller of the conveyance roller pair has: a contact portion configured to come into contact with the recording material when the recording material passes through the conveyance roller pair; and a non-contact portion configured to be out of contact with the recording material when the recording material passes through the conveyance roller pair, wherein the non-contact portion is provided with a static electricity eliminating function to discharge an electric charge imparted on the recording material.

Further features of the present invention will become apparent from the following description of exemplary embodiments with reference to the attached drawings.

### BRIEF DESCRIPTION OF THE DRAWINGS

FIG. 1 is a schematic structural view of an image forming apparatus according to Embodiment 1 of the present invention.

FIGS. 2A and 2B are structural views of a registration roller pair and a conveyance roller according to Embodiment 1 of the present invention.

FIG. 3 is an enlarged sectional view of an upper registration roller of the registration roller pair illustrated in FIG. 2A.

FIG. 4 is a graph showing a relationship between a surface voltage of a recording material on a downstream side of the registration roller pair and a gap between the recording material and a surface of a static electricity eliminating sheet according to Embodiment 1 of the present invention.

FIG. 5 is a graph showing a relationship between a surface voltage of a sheet on the downstream side of the registration roller pair and the number of supplied sheets in an endurance test according to Embodiment 1 and conventional examples.

FIG. 6 is a graph showing a relationship between a discharging start voltage and a product of a gap distance and an atmospheric pressure in conformity to the Paschen's law.

FIGS. 7A and 7B are structural views of a registration roller pair of an image forming apparatus according to Embodiment 2 of the present invention.

FIG. 8 is a structural view of an upper registration roller according to Embodiment 3 of the present invention.

FIG. 9 is an enlarged sectional view of the upper registration roller according to Embodiment 3 of the present invention.

FIG. 10 is a perspective view of a needle-like electrode according to Embodiment 3 of the present invention.

FIGS. 11A and 11B are views of the needle-like electrodes, for illustrating an effective static elimination range according to Embodiment 3 of the present invention. Specifically, FIG. 11A is a perspective view of a needle-like electrode portion, and FIG. 11B is a side view of the needle-like electrode portion as seen in a direction indicated by the arrow XIB of FIG. 11A.

### DESCRIPTION OF THE EMBODIMENTS

The embodiments of the present invention will be described in detail with reference to the accompanying drawings.

### Embodiment 1

(Overall Structure of Image Forming Apparatus)

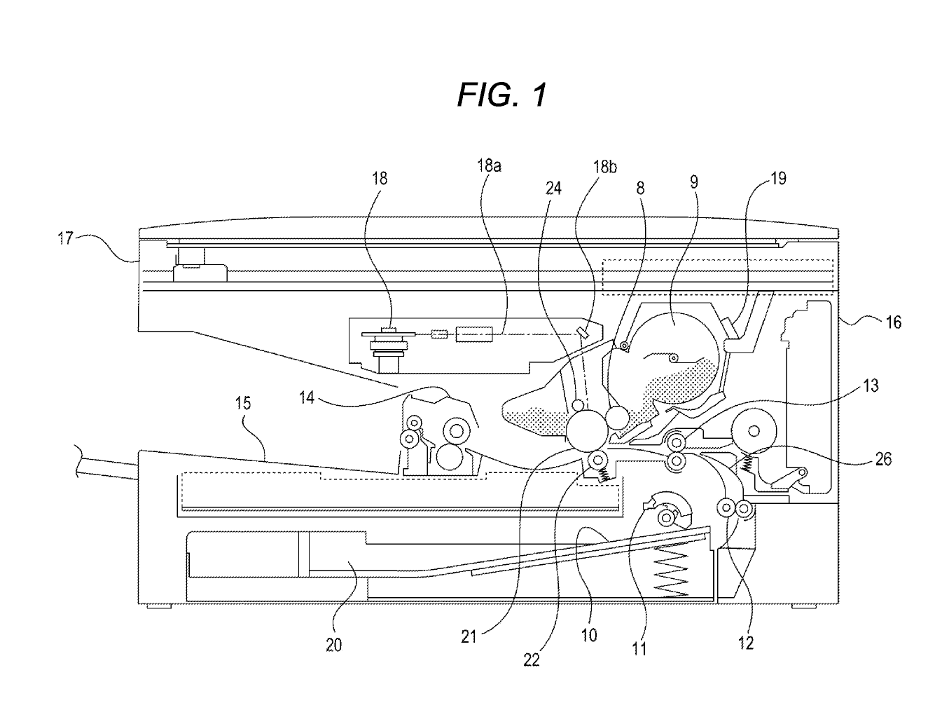

FIG. 1 is a schematic structural view of an image forming apparatus according to an embodiment of the present invention. In the embodiment, a digital copying machine or a facsimile machine using an electrophotographic printing method may be employed as the image forming apparatus.

First, the structure of the digital copying machine using the electrophotographic printing method will be described with reference to FIG. 1. An original reading unit 17, a laser scanner 18, a process cartridge 19, and a feed cassette 20 are provided in an apparatus main body 16. A photosensitive drum 21, a primary charging roller 24, a developing sleeve 8, and a toner container 9 are integrally incorporated in the process cartridge 19. Note that, the process cartridge 19 and the laser scanner 18 serve as an image forming portion.

At the time of image formation, the original reading unit 17 first reads an image of an original, and transmits image information to the apparatus main body 16. The primary charging roller 24 uniformly charges the photosensitive drum 21, and the laser scanner 18 irradiates the photosensitive drum 21 with a laser beam 18a via a mirror 18b based on the image information, to thereby form an electrostatic latent image on the photosensitive drum 21. Then, the developing sleeve 8 carries toner stored in the toner container 9, and transfers the toner onto the electrostatic latent image, to thereby develop the electrostatic latent image into a toner image.

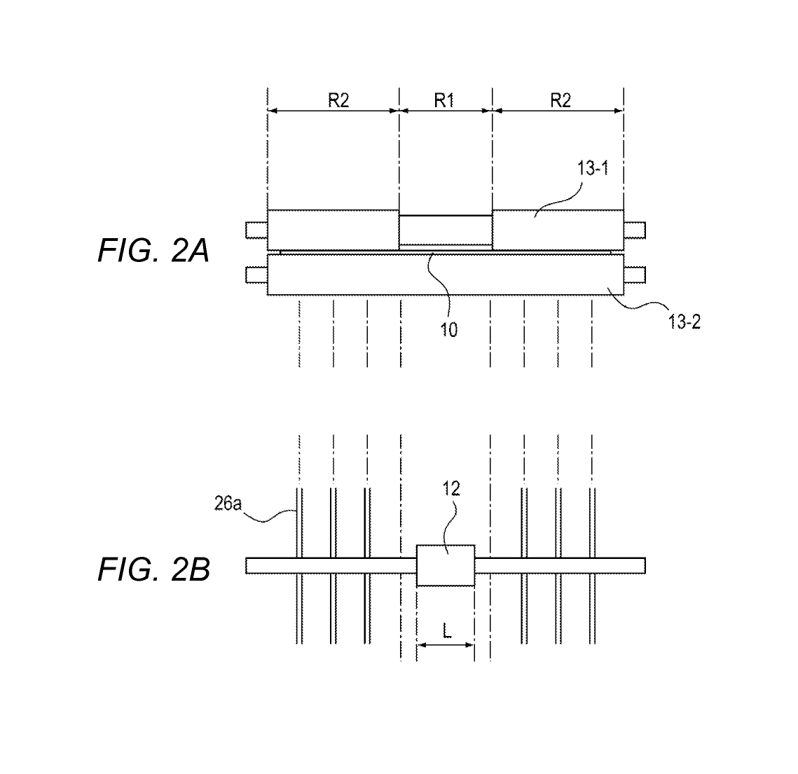

On the other hand, recording materials 10 stacked and stored in the feed cassette 20 are separated one by one and fed by a sheet feeding roller 11, and each of the recording materials 10 is conveyed by conveyance rollers 12 toward a registration roller pair 13 (conveyance roller pair) along conveyance ribs 26a (illustrated in FIG. 2B) provided on a conveyance guide 26.

The registration roller pair 13 conveys the recording material 10 in synchronization with the toner image on the photosensitive drum 21, and the toner image is transferred onto the recording material 10 at a nip portion between the photosensitive drum 21 and a transfer roller 22. The recording material 10 having the toner image transferred thereon is subjected to heat and pressure by a fixing device 14, and accordingly the image on the recording material 10 is fixed to the recording material 10. Then, the recording material 10 is delivered onto a stacking unit 15 provided outside the apparatus, and the image formation is completed.

Note that, roller surfaces of the sheet feeding roller 11 and the conveyance rollers 12 which nip and convey the recording material 10, and the conveyance ribs 26a of the conveyance guide 26 configured to guide the recording material 10 serve as a conveyance member of a conveyance portion.

(Structure of Registration Roller Pair)

FIGS. 2A and 2B are views of the registration roller pair 13 and a conveyance roller 12. FIG. 2A is a plan view of the registration roller pair 13, and FIG. 2B is a plan view of the conveyance roller 12. In FIG. 2A, the registration roller pair 13 includes an upper registration roller 13-1 and a lower registration roller 13-2. The upper registration roller 13-1 and the lower registration roller 13-2 form a nip therebetween to function as the conveyance portion configured to convey the recording material 10.

The lower registration roller 13-2 has an outer diameter of 16 mm, and a nitrile butadiene rubber (hereinafter referred to as “NBR”) as an insulating rubber is formed around a cored bar having an outer diameter of about 12 mm. The upper registration roller 13-1 is made of conductive free-cutting steel (for example, SUM24) and electrically grounded. Further, the upper registration roller 13-1 includes an R1 portion provided at a longitudinal center part thereof, and R2 portions provided on both sides of the R1 portion. The R1 portion serves as a non-contact portion which is out of contact with the recording material 10 which is being conveyed, and the R2 portions serve as a contact portion which is brought into contact with the recording material 10 which is being conveyed so as to convey the recording material 10. Further, the R1 portion is arranged in a region overlapping with the conveyance roller 12 which is located on an upstream side in a conveyance direction of the recording material 10.

Each R2 portion (contact portion) has an outer diameter (first outer diameter) of 13 mm at a part which forms the nip formed between the R2 portion and the lower registration roller 13-2, and the R1 portion (non-contact portion) has an outer diameter (second outer diameter) of 11 mm to 12.5 mm at a part corresponding to the sheet feeding roller 11 and the conveyance roller 12. The outer diameter of the R1 portion is set smaller than the outer diameter of the R2 portion. Note that, the outer diameters of the lower registration roller 13-2 and the upper registration roller 13-1 may be set freely within a range in which the recording material 10 can be conveyed.

Note that, in the embodiment, a length L of the conveyance roller 12 is set to 40 mm, and a length of the R1 portion is set to 50 mm. That is, the length of the R1 portion is set larger than the length of the conveyance roller 12 which is located on the upstream side in the conveyance direction of the recording material 10, and hence electric charges imparted on the recording material 10 by contact between the recording material 10 and the sheet feeding roller 11 or the conveyance roller 12 may reliably be discharged and eliminated at the R1 portion. Further, a length of the R2 portion is 150 mm.

Thus, the range of the R1 portion in the longitudinal direction of the registration roller pair 13 includes at least a range in which the recording material 10 is brought into contact with the conveyance roller 12 at a position on the upstream side of the registration roller pair 13 in the conveyance direction.

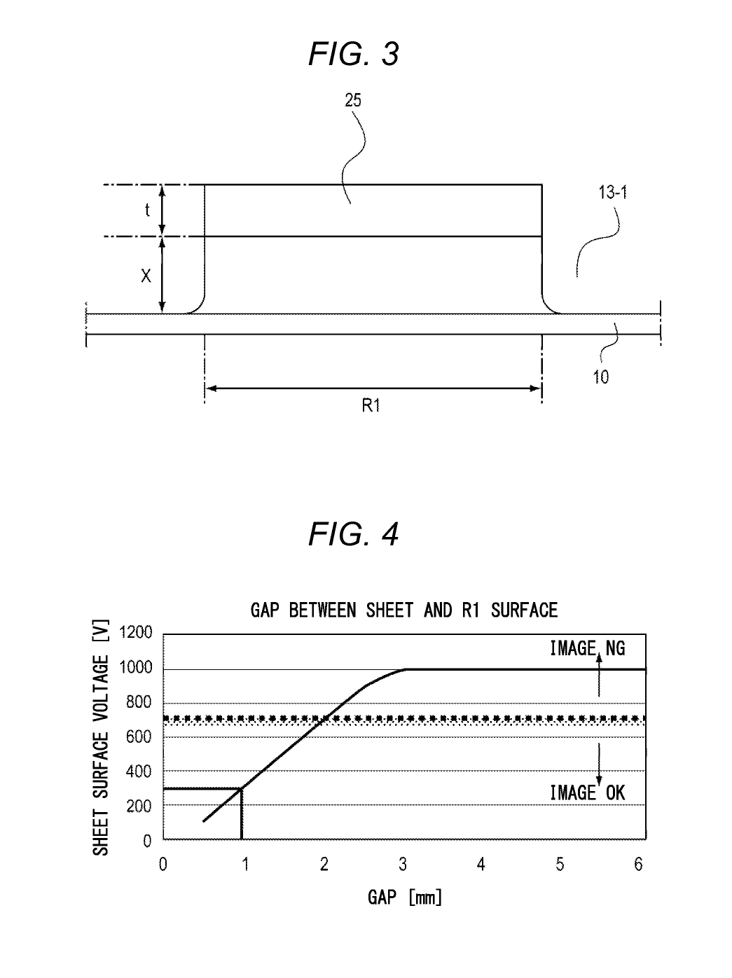

FIG. 3 is an enlarged sectional view illustrating the vicinity of the R1 portion of the upper registration roller 13-1 of the registration roller pair 13.

A static electricity eliminating sheet 25 (static electricity eliminating member) configured to discharge the electric charges imparted on the recording material 10 is adhered to a surface of the R1 portion. The static electricity eliminating sheet 25 is formed of a base material and a conductive double-coated pressure sensitive adhesive tape. The base material is obtained by mixing conductive carbon fibers into a nonwoven fabric made of, for example, polyester, polypropylene, polyethylene terephthalate, or nylon fibers, or coating a surface of resin fibers with a conductive film. The base material has a thickness of 500 μm, and the double-coated pressure sensitive adhesive tape has a thickness of 140 μm. The static electricity eliminating sheet 25 has a surface resistance of about 10⁴ to 10⁶ ohms per square (Ω/□). Note that, the thickness of the base material and the thickness of the double-coated pressure sensitive adhesive tape may be set freely depending on the surface resistance of the base material. A gap is secured for the surface of the R1 portion so as to prevent the recording material 10 from being brought into contact with the R1 portion when the recording material 10 passes through the registration roller pair 13.

(Static Elimination Action of Static Electricity Eliminating Sheet 25)

Tip end portions of the conductive carbon fibers or the resin fibers inside the static electricity eliminating sheet 25 facilitate local concentration (electric field concentration) of induced electric charges due to a tip effect.

In a low-temperature and low-humidity environment, in particular, the recording material 10 such as paper which is left standing for a sufficiently long period of time has an increased surface resistance and volume resistance, and is therefore liable to be charged by friction against an insulating object. Under such a condition, the surface of the recording material 10 is charged at a time of conveyance only by friction between the recording material 10 and the sheet feeding roller 11, the conveyance roller 12, the lower registration roller 13-2, or the like, which has a surface layer generally made of an insulating rubber material. When an absolute value of the charging voltage is sufficiently high, the toner image on the photosensitive drum may fail to be transferred normally at the transfer nip portion, and an image defect may occur due to an uneven image caused by an uneven electrostatic charge among regions of the sheet.

In the embodiment, when the recording material 10 is charged, an electric field is generated between the recording material 10 and the surface of the static electricity eliminating sheet 25 adhered to the R1 portion of the upper registration roller 13-1. As described above, significant electric field concentration occurs in the surface of the static electricity eliminating sheet 25, and gas molecules present between the recording material 10 and the static electricity eliminating sheet 25 are ionized. Once the gas molecules are ionized, the gas molecules are subjected to a force from the electric field depending on an electrical polarity thereof and accelerated toward the surface of the static electricity eliminating sheet 25 or the recording material 10 so that the gas molecules impinge on gas molecules in the air. That is, a current flows between the recording material 10 and the static electricity eliminating sheet 25 via the ions, and thus the static electricity of the recording material 10 is eliminated.

For example, when the recording material 10 is charged at a positive polarity, the surface of the static electricity eliminating sheet 25 is charged at a negative polarity. Then, the gas molecules are ionized through the electric field concentration occurring in the surface of the static electricity eliminating sheet 25. Negative ions are attracted to the surface of the recording material 10, and neutralize the positive charges of the recording material 10 to eliminate the static electricity of the recording material 10.

On the other hand, positive ions are attracted to the surface of the static electricity eliminating sheet 25. The upper registration roller 13-1 is electrically grounded, and negative charges are supplied thereto. The negative charges neutralize the positive ions.

Note that, when the recording material 10 is charged at a negative polarity, the positive charges and the negative charges are replaced with each other in an electrical aspect, but the static electricity of the recording material 10 is eliminated similarly to the case where the recording material 10 is charged at a positive polarity. In this case, the negative charges flow from the upper registration roller 13-1 to the ground side, and thus the upper registration roller 13-1 is neutralized.

FIG. 4 is a graph showing a relationship between a surface voltage (vertical axis) of the recording material 10 on a downstream side of the registration roller pair 13 at a part corresponding to the R1 portion and a gap (horizontal axis) between the recording material 10 and the surface of the static electricity eliminating sheet 25 according to the embodiment. As a condition of measurement, a voltmeter manufactured by TREK, INC. (product name: MODEL 341) was used, and paper having a basis weight of 64 g/m² was used in a low-temperature and low-humidity environment at one atmospheric pressure.

Conventionally, as a result of investigating a relationship between a value of increase in voltage of the recording material 10 due to the friction against the roller and a level of an image defect due to toner scattering, a sheet voltage at which the image defect is allowable falls within a range of about 700 V (predetermined voltage) or less, and the image defect is not allowable when the sheet voltage exceeds 700 V.

As can be seen from FIG. 4, along with increase in gap between the recording material 10 and the surface of the static electricity eliminating sheet 25, the sheet voltage on the downstream side of the registration roller pair 13 increased. When the gap was 2 mm, the sheet voltage was about 700 V, and an image defect started to occur. Further, when the gap was 3 mm, the sheet voltage was about 1,000 V. When the gap was equal to or larger than 3 mm, the sheet voltage did not increase, and hence it was found that the static elimination performance did not change.

As described above, along with the increase in gap between the recording material 10 and the static electricity eliminating sheet 25, the intensity of the electric field between the recording material 10 and the static electricity eliminating sheet 25 was decreased, and hence the static elimination effect was decreased. Further, when the gap exceeded 2 mm, the effect of reducing the image defect was not obtained. In order to prevent such a phenomenon, according to the embodiment, a gap X between the recording material 10 and the surface of the static electricity eliminating sheet 25 is set smaller than 2 mm (first length) so as to cause discharging when the sheet voltage exceeds 700 V at which the image defect starts to occur. In the embodiment, the sheet voltage at which the image defect starts to occur is 700 V, but may vary depending on the condition, and hence it is necessary to determine the length of the gap X by defining the sheet voltage at which the image defect occurs depending on the structure of the image forming apparatus.

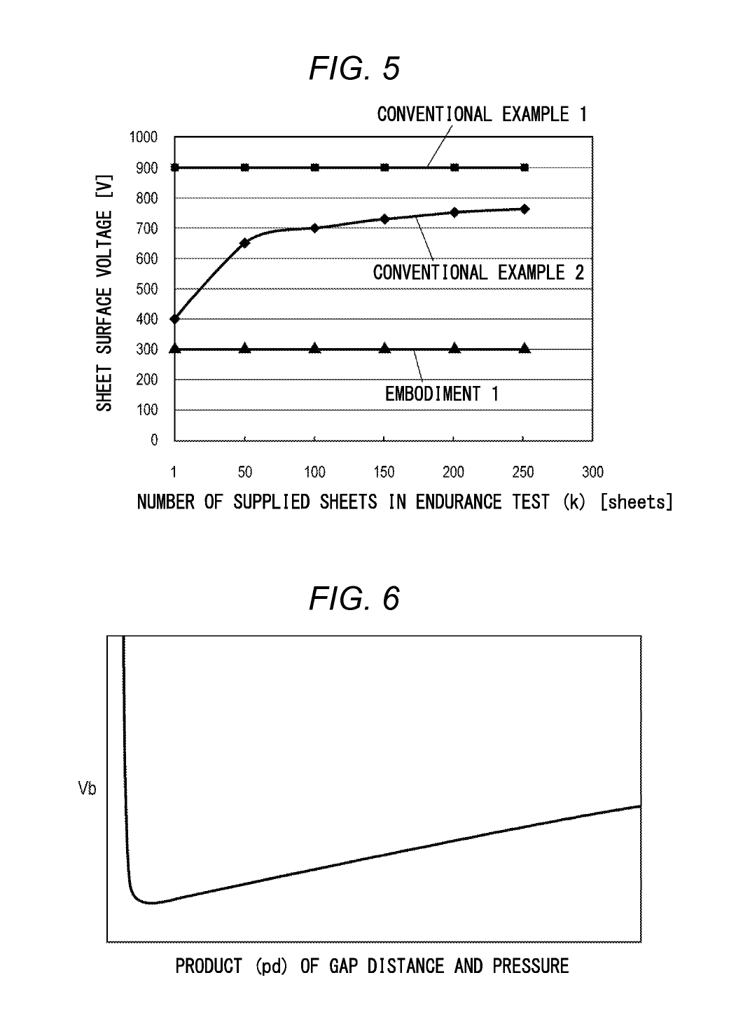

FIG. 5 is a graph showing a relationship between a surface voltage of a sheet on the downstream side of the registration roller pair 13 and the number of supplied sheets in an endurance test according to the embodiment and conventional examples.

FIG. 5 shows a relationship between a surface voltage of the recording material 10 on the downstream side of the registration roller pair 13 at a part corresponding to the R1 portion and the number of continuously supplied sheets in the endurance test according to Embodiment 1 of the present invention in which the gap X is set to 1.0 mm, and to Conventional Examples 1 and 2. In the structure (not shown) of Conventional Example 1, the outer diameter of the upper registration roller 13-1 is constant in the longitudinal direction within a range in which the recording material 10 is nipped, and the static electricity eliminating sheet 25 is not provided on the surface of the upper registration roller 13-1. Thus, the static electricity of the recording material 10 is eliminated by utilizing conductivity of a metal roller.

The structure (not shown) of Conventional Example 2 is obtained by providing a static electricity eliminating sheet on the conveyance guide 26 located in a conveyance path on an upstream side of the transfer nip portion in the structure of Conventional Example 1. As a condition of measurement, a voltmeter manufactured by TREK, INC. (product name: MODEL 341) was used, and A4 paper having a basis weight of 64 g/m² was used in a low-temperature and low-humidity environment at one atmospheric pressure.

In Conventional Example 1, due to the charging by friction between the recording material 10 and the sheet feeding roller 11 or the conveyance roller 12 located on the upstream side of the registration roller pair 13, the surface voltage of the recording material 10 on the downstream side of the registration roller pair 13 became about 900 V, and therefore exceeded the sheet voltage at which the image defect due to toner scattering was allowable.

In Conventional Example 2, the static elimination performance may be maintained until the number of supplied sheets in the endurance test reaches about 100,000. However, as the number of supplied sheets in the endurance test increases, due to the contact between the recording material 10 and the static electricity eliminating sheet, the static electricity eliminating sheet may be chipped or paper dust may accumulate on the static electricity eliminating sheet. For this reason, the static elimination effect is decreased and the sheet voltage exceeds the sheet voltage at which the image defect due to toner scattering is allowable.

In Embodiment 1, the outer diameter of the upper registration roller 13-1 is reduced within a range wider than the widths of the sheet feeding roller 11 and the conveyance roller 12, and both edges of the recording material 10 are brought into a nipped state. Thus, it is possible to maintain a constant distance between the recording material 10 and the surface of the static electricity eliminating sheet 25 so that the static elimination effect becomes stable. Further, it is possible to prevent the decrease in static elimination effect caused by the chipping of the recording material 10 or the accumulation of paper dust due to the contact between the recording material 10 and the static electricity eliminating sheet 25. With the effects described above, the sheet voltage does not exceed the sheet voltage at which the image defect due to toner scattering is allowable.

Note that, the voltage level that causes discharging generally conforms to the Paschen's law, and may be expressed by a function based on a gap distance “d” between the recording material 10 and the surface of the static electricity eliminating sheet 25, and on an atmospheric pressure “p” of an environment in which the image forming apparatus is installed. A discharging start voltage (Vb) is expressed by the following expression. In the following expression, “B” and “C” are constants, respectively.

Vb=Bpd/{ln(pd)+C}

FIG. 6 is a graph showing a relationship between the discharging start voltage and a product of the gap distance “d” and the atmospheric pressure “p” in conformity to the Paschen's law. As shown in FIG. 6, the discharging start voltage may be determined relative to the product of the gap distance “d” and the atmospheric pressure “p”. That is, when the image forming apparatus is operated in such an apparatus environment in which the atmospheric pressure “p” is constant, the discharging start voltage Vb is proportional to the gap distance “d”. Therefore, when the gap distance “d” is set, a predetermined discharging start voltage may be set.

As described above, the outer diameter of the part of the upper registration roller 13-1 corresponding to the conveyance roller 12 is reduced as the non-contact portion, and the static electricity eliminating sheet 25 is provided to the non-contact portion. As a result, the static electricity of the recording material 10 brought into friction against the conveyance roller 12 may be eliminated reliably. Therefore, the image defect due to the charging of the recording material 10 may be prevented.

### Embodiment 2

Next, an image forming apparatus according to another embodiment of the present invention will be described with reference to the accompanying drawings.

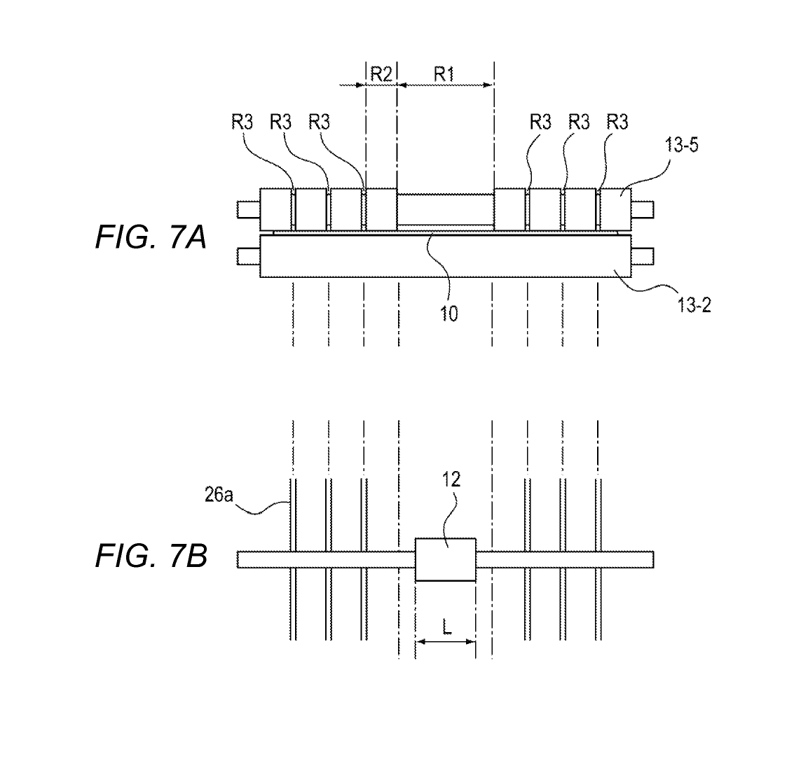

FIG. 7A is a view of a registration roller pair of the image forming apparatus according to another embodiment of the present invention. In the embodiment, in addition to the components of Embodiment 1 described above, an upper registration roller 13-5 includes R3 portions (non-contact portion) which are out of contact with the recording material 10 at positions corresponding to the conveyance ribs 26a (FIG. 7B) provided on the upstream side of the registration roller pair 13. The static electricity eliminating sheets are adhered to the respective R3 portions.

In FIG. 7A, the upper registration roller 13-5 and the lower registration roller 13-2 form a nip therebetween to function as the conveyance portion configured to convey the recording material 10. The R2 portions are portions which form the nips with the lower registration roller 13-2. The R1 portion is a portion corresponding to the sheet feeding roller 11 and the conveyance roller 12. The R3 portions are portions corresponding to the conveyance ribs 26a provided on the upstream side of the registration roller pair 13. The outer diameters of the R1 portion and each R3 portion are set smaller than the outer diameter of each R2 portion. The static electricity eliminating sheets (not shown) are adhered to the surfaces of the R1 portion and the R3 portions. The surfaces of the R1 portion and the R3 portions are not brought into contact with the sheet, and gaps are provided therebetween.

When the R3 portions are provided as described above, similarly to the case where the R1 portion is provided so as to eliminate the electric charges imparted on the recording material 10 due to the sheet feeding roller 11 and the conveyance roller 12, the electric charges generated due to the friction between the conveyance ribs 26a and the recording material 10 are eliminated.

### Embodiment 3

Next, an image forming apparatus according to another embodiment of the present invention will be described with reference to the accompanying drawings.

The embodiment is different from Embodiment 1 in the surface state of a part of the upper registration roller corresponding to the widths and the conveyance roller 12 in the longitudinal direction of the upper registration roller. In all other respects, Embodiment 3 is similar to Embodiment 1, and redundant description is therefore omitted herein.

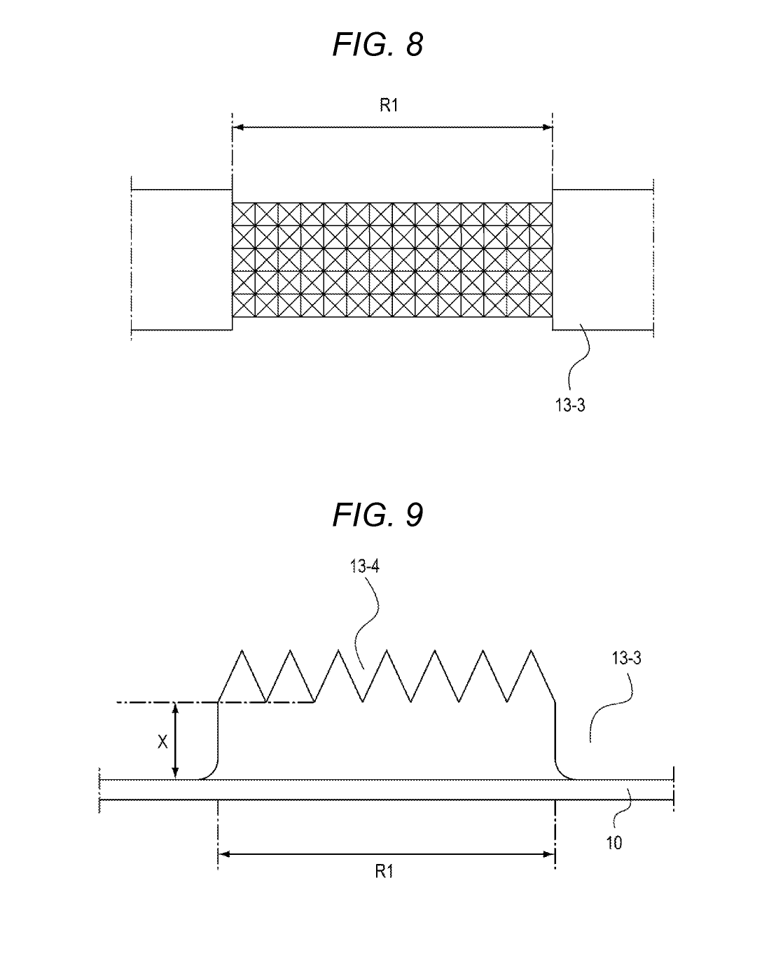

FIG. 8 is an enlarged view illustrating the vicinity of an R1 portion of an upper registration roller 13-3 according to the embodiment.

The upper registration roller 13-3 includes a plurality of needle-like electrodes configured to bring on the discharging at tip end portions thereof. The needle-like electrodes are provided on the entire circumferential surface of the R1 portion corresponding to the widths of the sheet feeding roller 11 and the conveyance roller 12 in the longitudinal direction. That is, the tip end portions of the needle-like electrodes are arranged in a radial fashion in a radial direction of the upper registration roller 13-3.

The upper registration roller 13-3 is made of conductive SUM24 and electrically grounded. The R1 portion is longer than the widths of the sheet feeding roller 11 and the conveyance roller 12. Further, the R1 portion has an outer diameter of about 11 mm to 12.5 mm, and the outer diameter of the R1 portion is set smaller than the outer diameter of the R2 portion. Note that, the outer diameter of the upper registration roller 13-3 may be set freely within a range in which the recording material 10 can be conveyed.

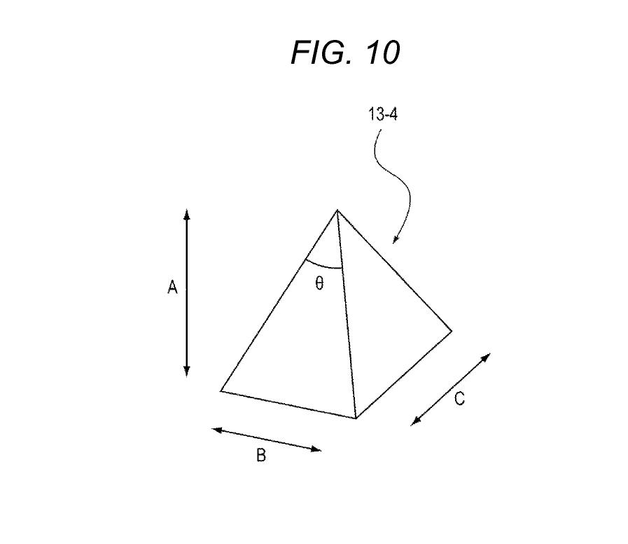

FIG. 9 is an enlarged sectional view illustrating the vicinity of the R1 portion of the upper registration roller 13-3. FIG. 10 is a perspective view of one of the needle-like electrodes. As illustrated in FIGS. 9 and 10, a plurality of needle-like electrodes 13-4 are formed on the surface of the R1 portion. A height of the needle-like electrodes 13-4 is represented by “A”, a pitch of the needle-like electrodes 13-4 in the longitudinal direction is represented by “B”, and a pitch of the needle-like electrodes 13-4 in the circumferential direction is represented by “C”. Each of the needle-like electrodes 13-4 is a rectangular-pyramid protrusion having a length of about 0.5 mm to 5 mm on one side. Note that, the shape of the needle-like electrode 13-4 may be set freely within a range in which the function of this structure is satisfied. The surface of the R1 portion is not brought into contact with the recording material 10, and the gap X is provided therebetween.

In this structure, when the recording material 10 is charged, an electric field is generated between the recording material 10 and the tip end portions of the needle-like electrodes 13-4 at the R1 portion of the upper registration roller 13-3. When the acuity (sharpness) of the tip end portions of the needle-like electrodes 13-4 is high, that is, when the value of B/A is small, significant electric field concentration occurs in the tip end portions of the needle-like electrodes 13-4, and gas molecules present between the recording material 10 and the tip end portions of the needle-like electrodes 13-4 are ionized. Once the gas molecules are ionized, the gas molecules are subjected to a force from the electric field depending on an electrical polarity thereof and accelerated toward the tip end portions of the needle-like electrodes 13-4 or the recording material 10 so that the gas molecules impinge on gas molecules in the air. That is, a current flows between the recording material 10 and the tip end portions of the needle-like electrodes 13-4 via the ions, and thus the static electricity of the recording material 10 is eliminated.

The pitch and the depth of the needle-like electrodes 13-4 are important factors to determine an effective static elimination range of the needle-like electrodes 13-4, and are determined depending on the distance between the recording material 10 and the needle-like electrodes 13-4, and on necessary static elimination performance.

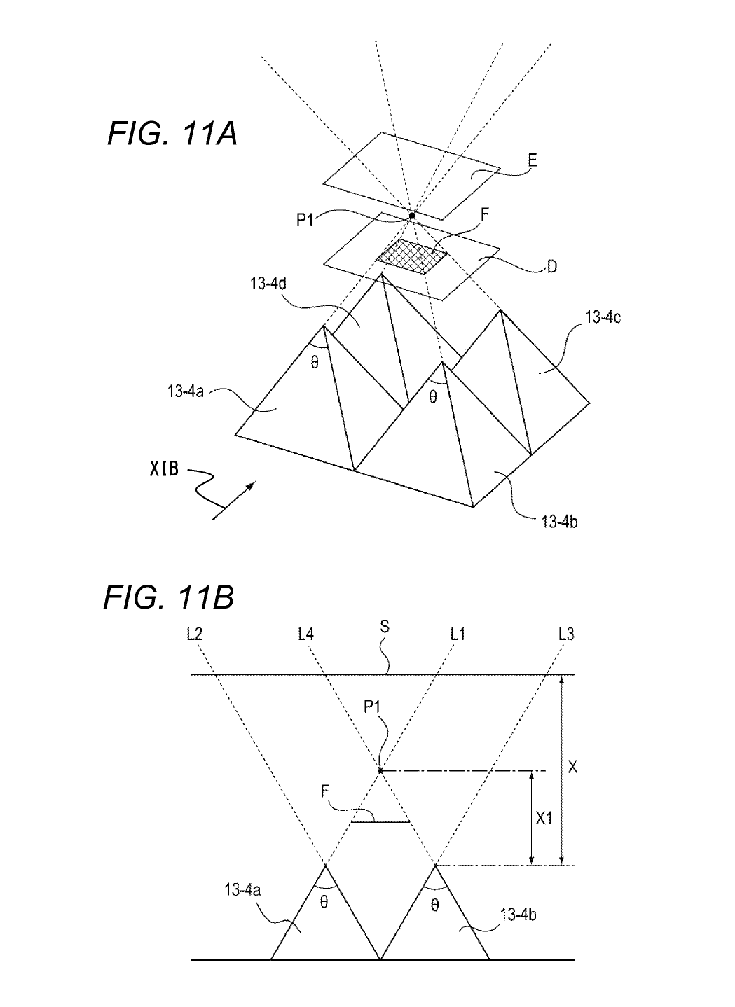

FIGS. 11A and 11B are views of the electrode portion, for illustrating the effective static elimination range. FIG. 11A is a perspective view of the electrode portion, and FIG. 11B is a side view of the electrode portion as seen in the direction indicated by the arrow XIB of FIG. 11A. In FIGS. 11A and 11B, needle-like electrodes 13-4a, 13-4b, 13-4c, and 13-4d are adjacent to one another.

In FIG. 11A, the dotted lines extending from the tip end portion of each needle-like electrode 13-4 along the sides thereof indicate boundaries of the static elimination range. With the dotted lines as the boundaries, the static elimination range is defined as an approximate range in which a single needle-like electrode 13-4 exerts its static elimination performance. When the recording material 10 is located at the position D of FIG. 11A, the static elimination ranges of two adjacent needle-like electrodes 13-4 are not connected to each other with an overlap, and hence a range F is present, in which the static elimination is not sufficient. When the recording material 10 is spaced away from the needle-like electrodes 13-4 to the position E, the effective static elimination ranges of the respective needle-like electrodes 13-4 overlap with each other, and hence the static electricity of the recording material 10 may be eliminated thoroughly (uniformly).

The above-mentioned state will be described in detail with reference to FIG. 11B. In FIG. 11B, the approximate effective static elimination ranges of the needle-like electrodes 13-4a and 13-4b adjacent to each other correspond to a range defined between extension lines L1 and L2 along the sides of the needle-like electrode 13-4a, and to a range defined between extension lines L3 and L4 along the sides of the needle-like electrode 13-4b, respectively. That is, the range defined between the extension lines L1 and L2 corresponds to the effective static elimination range of the needle-like electrode 13-4a, and the range defined between the extension lines L3 and L4 corresponds to the effective static elimination range of the needle-like electrode 13-4b. Thus, when the recording material 10 is located closer to the electrode portion with respect to an intersection point P1 between the extension lines L1 and L4, the range F is present, in which the static elimination is not sufficient. Therefore, in order to perform sufficient static elimination, the recording material 10 needs to be located farther away from the needle-like electrodes 13-4 than the intersection point P1.

Accordingly, a minimum length X1 of the gap is equal to the height A of the needle-like electrode 13-4, and is expressed by the following expression assuming that “θ” represents an acute tip angle of the needle-like electrode 13-4.

$$X 1 = A = \frac{\sqrt{{B}^{2} - {C}^{2} \cdot {tan}^{2} ( \frac{θ}{2} )}}{2 \cdot tan ( \frac{θ}{2} )}$$

However, along with increase in distance between the recording material 10 and the needle-like electrodes 13-4, the intensity of the electric field between the recording material 10 and the needle-like electrodes 13-4 is decreased, and hence the static elimination effect is decreased. In this structure, when the distance between the recording material 10 and the tip end portions of the needle-like electrodes 13-4 exceeded 2 mm, the effect of reducing the image defect was not obtained. Thus, the distance between the recording material 10 and the tip end portions of the needle-like electrodes 13-4 only needs to be set to a distance equal to or larger than X1 (second length) of the above-mentioned condition when the recording material 10 and the needle-like electrodes 13-4 are closest to each other, and equal to or smaller than 2 mm so as to perform uniform static elimination. That is, the length X of the gap only needs to be set within a range of X1≦X≦2 mm.

According to the embodiment, the static elimination effect similar to that of Embodiment 1 may be obtained. That is, the outer diameter of the part of the upper registration roller 13-3 corresponding to the widths of the sheet feeding roller 11 and the conveyance roller 12 is reduced, and hence both edges of the recording material 10 are brought into a nipped state. Thus, it is possible to maintain a constant distance between the recording material 10 and the tip end portions of the needle-like electrodes 13-4 at the R1 portion of the upper registration roller 13-3 so that the static elimination effect becomes stable. Further, it is possible to prevent the decrease in static elimination effect caused by the chipping of the recording material 10 or the accumulation of paper dust due to the contact between the recording material 10 and the tip end portions of the needle-like electrodes 13-4.

According to the embodiments of the present invention, the static electricity eliminating member is provided on the surface of the non-contact portion, and the gap between the static electricity eliminating member and the recording material is smaller than the first length at which the discharging occurs when the charging voltage exceeds a predetermined value.

Thus, when the recording material is charged at a voltage higher than the predetermined voltage, the static electricity of the recording material may be eliminated in a stable and uniform manner by reducing the non-uniform static elimination. Further, the recording material is nipped by the contact portion of at least one conveyance roller of the conveyance roller pair, and hence the image defect, such as an uneven image formed due to non-uniform charging, may be prevented without influence of the curl of the recording material.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-192239, filed Aug. 31, 2012, which is hereby incorporated by reference herein in its entirety.

What is claimed is:

1. An image forming apparatus, comprising:
an image forming portion configured to form an image on a recording material; and
a conveyance portion configured to convey the recording material so that the image is formed on the recording material by the image forming portion, the conveyance portion including a conveyance roller pair configured to nip and convey the recording material,
wherein at least one conveyance roller of the conveyance roller pair has:
a contact portion configured to come into contact with the recording material when the recording material passes through the conveyance roller pair; and
a non-contact portion configured to be out of contact with the recording material when the recording material passes through the conveyance roller pair,
wherein the non-contact portion is provided with a static electricity eliminating function to discharge an electric charge imparted on the recording material.

2. An image forming apparatus according to claim 1, wherein, when the recording material passes through the conveyance roller pair, a gap between the recording material and a surface carrying out the static electricity eliminating function is smaller than a first length at which a discharge occurs when a voltage of the electric charge imparted on the recording material exceeds a predetermined voltage.

3. An image forming apparatus according to claim 1, wherein the static electricity eliminating function is provided by a static electricity eliminating sheet containing a conductive fiber which causes electric field concentration.

4. An image forming apparatus according to claim 1, wherein the static electricity eliminating function is provided by a plurality of needle-like electrodes of which tip end portions are arranged in a radial fashion in a radial direction of the at least one conveyance roller.

5. An image forming apparatus according to claim 2, wherein the static electricity eliminating function is provided by a plurality of needle-like electrodes of which tip end portions are arranged in a radial fashion in a radial direction of the at least one conveyance roller, and
wherein the gap is larger than a second length at which the plurality of needle-like electrodes are allowed to uniformly eliminate the electric charge imparted on a range of the recording material which passes through the non-contact portion.

6. An image forming apparatus according to claim 1, further comprising a conveyance member provided upstream of the conveyance roller pair in a conveyance direction, the conveyance member including at least one of another conveyance roller and a conveyance rib which are configured to convey the recording material,
wherein a range of the non-contact portion in a longitudinal direction of the conveyance roller pair includes at least a range in which the recording material is brought into contact with the conveyance member.

7. An image forming apparatus according to claim 2, wherein the predetermined voltage includes a voltage at which a defect occurs in the image formed by the image forming portion.

8. An image forming apparatus according to claim 1, wherein the at least one conveyance roller is electrically grounded.
